(19) United States
(12) Patent Application Publication
(10) Pub. No.: US 2003/0039189 A1
(43) Pub. Date: Feb. 27, 2003

(54) Optical medium identification method and apparatus therefor

(75) Inventors: Jak-heun Yang, Gyeonggi-do (KR); Hyoung-kyu Lee, Jeollanam-do (KR)

Correspondence Address: STAAS & HALSEY LLP, 700 11TH STREET, NW, SUITE 500, WASHINGTON, DC, 20001, US

(73) Assignee: Samsung Electronics Co., Ltd., Suwon-city (KR)

(21) Appl. No.: 10/223,345

(22) Filed: Aug. 20, 2002

(30) Foreign Application Priority Data
Aug. 25, 2001 (KR) 2001-51586

(51) Int. Cl. G11B 7/00

(52) U.S. Cl. 369/53.24

(57) ABSTRACT

A disc identification method and an apparatus for identifying a type of a disc placed in a disc reproducing system that can reproduced data from 2 or more types of discs by using both a first laser diode for a first optical medium (CD) type and a second laser diode for a second optical medium (DVD) type. The method of identifying the type of the disc in the disc reproducing system includes performing a first focus search mode by turning on the laser diode for the first optical medium type installed in the disc reproducing system, detecting a peak-to-peak value of a focus error signal detected while the first focus search mode is performed, identifying the type of the disc placed on the disc reproducing system by comparing the peak-to-peak value of the detected focus error signal with a predetermined reference value, performing a second focus search mode by turning on the second laser diode for the second optical medium type installed in the disc reproducing system if it is determined that the disc placed on the disc reproducing system is the second optical medium type, and checking the number of peaks of an RF sum signal detected when the second focus search mode is performed to identify the type of the placed disc. Therefore, the possibility of an incorrect determination on the type of the disc in the disc reproducing system is lowered.

### CROSS-REFERENCE TO RELATED APPLICATIONS

This application claims the benefit of Korean Patent Application No. 2001-51586, filed Aug. 25, 2001, in the Korean Industrial Property Office, the disclosure of which is incorporated herein by reference.

### BACKGROUND OF THE INVENTION

1. Field of the Invention

The present invention relates to an optical medium identification method and apparatus, and more particularly, to an optical medium identification method and an apparatus for identifying a type of an optical medium placed on a system which can reproduce data from more than two types of optical media.

2. Description of the Related Art

As an example of a system which can reproduce data from more than two types of optical media, there is a digital versatile disc (DVD) reproducing system. In the DVD reproducing system, data on a single-layer DVD, a dual-layer DVD, and a CD can be reproduced.

In the DVD reproducing system, a first wavelength of a first light source in a pickup for the CD is 780 nm, and a second wavelength of a second light source in the pickup for a DVD is 635˜650 nm. For this difference, a pickup unit of the system has a first laser diode for the CD and a second laser diode for the DVD separately. However, in a focus search mode to perform during an interval identifying the type of a disc placed on the DVD reproducing system, only the second laser diode for the DVD can be used in the DVD reproducing system. This is because the second wavelength and a focus length of the second light source for the DVD are shorter than those of the first light source for the CD and because the identifying of the type of an optical medium is easier.

However, since in the DVD reproducing apparatus, an RF sum signal changes greatly depending on deviation of a modulation degree of the disc or the type of the pickup unit, an incorrect determination on the type of the disc frequently occurs. For example, a slope of an RF sum signal which is detected when a placed disc is the CD is gentler than that of the RF sum signal of the single-layer DVD. However, as described above, if the slope of the RF sum signal generated according to the deviation of the modulation degree of the disc or the type of the pickup unit is detected as steeper than an actual slope though the placed disc is the CD, it may be determined that the placed disc is the single-layer DVD. In addition, if the slope of the RF sum signal generated by the reasons described above is gentler and if it is detected that the number of peaks of the RF sum signal is 2 though the placed disc is the CD, it may be determined that the placed disc is the dual-layer DVD.

Also, when the placed disc is the dual-layer DVD, if the RF sum signal changes due to the reasons described above, it may be determined that the placed disc is the CD. Moreover, when the placed disc is the single-layer DVD, if the RF sum signal also changes due to the above reasons, it may be determined that the placed disc is the CD.

### SUMMARY OF THE INVENTION

To solve the above and other problems, it is an object of the present invention to provide a disc identification method and apparatus which identifies the type of a placed disc using both a laser diode for a first optical medium (CD) type and a laser diode for a second optical medium (DVD) type in a disc reproducing system that can reproduce data from 2 or more types of discs.

Additional objects and advantages of the invention will be set forth in part in the description which follows and, in part, will be obvious from the description, or may be learned by practice of the invention.

To accomplish the above and other objects according to an embodiment of the present invention, a method of identifying a type of a disc in a disc reproducing system that reproduces data from 2 or more types of disc includes performing a first focus search mode by turning on a first laser diode of a first optical medium type installed in the disc reproducing system, detecting a peak-to-peak value of a focus error signal detected when the focus search mode is performed, identifying the type of the disc placed on the disc reproducing system by comparing the peak-to-peak value of the detected focus error signal with a predetermined reference value, performing a second focus search mode by turning on a second laser diode for a second optical medium type installed in the disc reproducing system if it is determined that the disc placed on the disc reproducing system is the second optical medium type, and checking the number of peaks of an RF sum signal detected when the second focus search mode is performed, and identifying the type of the placed disc.

It is possible that in identifying the type of the disc by using the peak-to-peak value of the focus error signal, if the peak-to-peak value of the focus error signal is greater than the predetermined reference value, it is determined that the disc is the first optical medium type. If the peak-to-peak value of the focus error signal is not greater than the predetermined reference value, it is determined that the disc is the second optical medium type.

It is possible that in identifying the type of the disc by using the number of peaks of the RF sum signal, whether the disc is a single-layer optical medium or a dual-layer optical medium is determined according to whether the number of peaks of the RF sum signal detected in a predetermined period is 2.

Also, to accomplish the above and other objects according to another embodiment of the present invention, an apparatus of a disc reproducing system that reproduces data from 2 or more types of discs includes a pickup unit which comprises a first laser diode for a first optical medium type, a second laser diode for a second optical medium type, and an optical detector that detects the quantity of a beam reflected from the disc, an RF signal and servo error signal processing unit controlling the power of the first laser diode for the first optical medium type and the second laser diode for the second optical medium type and generating a focus error signal and an RF sum signal based on the quantity of a beam detected by the optical detector, a servo unit which detects the size of the focus error signal output from the RF signal and servo error signal processing unit, and a system control unit controlling the RF signal and servo error signal processing unit to turn on and off the first and second laser diodes and the servo unit to detect the size of the focus error signal.

The RF signal and servo error signal processing unit turns on the first laser diode for the first optical medium type to perform the first focus search mode, and the type of the disc is identified based on the detected size of the focus error signal. If it is determined that the disc is the second optical medium type, the RF signal and servo error signal processing unit turns on the second laser diode for the second optical medium type to perform the second focus search mode, and the type of the disc is identified based on the number of an RF sum signal detected in a predetermined period.

It is possible that the predetermined period is an up period or down period of a focus driving voltage provided to the pickup unit to perform the second focus search mode.

### BRIEF DESCRIPTION OF THE DRAWINGS

These and other objects and advantages of the invention will become apparent and more readily appreciated from the following description of the preferred embodiments, taken in conjunction with the accompanying drawings of which:

FIG. 1 is a block diagram of a disc identification apparatus according to an embodiment of the present invention;

FIG. 2A is an example of a waveform detected in a focus search mode interval when a CD is placed on the disc identification apparatus of FIG. 1;

FIG. 2B is an example of a waveform detected in a focus search mode interval when a single-layer DVD is placed on the disc identification apparatus of FIG. 1;

FIG. 2C is an example of a waveform detected in a focus search mode interval when a dual-layer DVD is placed on the disc identification apparatus of FIG. 1;

FIG. 3A is another example of a waveform detected in a focus search mode interval when a single-layer DVD is placed on the disc identification apparatus of FIG. 1;

FIG. 3B is another example of a waveform detected in a focus search mode interval when a dual-layer DVD is placed on the disc identification apparatus of FIG. 1; and

FIG. 4 is a flowchart of a disc identification method in the disc identification apparatus of FIG. 1.

### DESCRIPTION OF THE PREFERRED EMBODIMENTS

Reference will now be made in detail to the present preferred embodiments of the present invention, examples of which are illustrated in the accompanying drawings, wherein like reference numerals refer to the like elements throughout. The embodiments are described below in order to explain the present invention by referring to the figures.

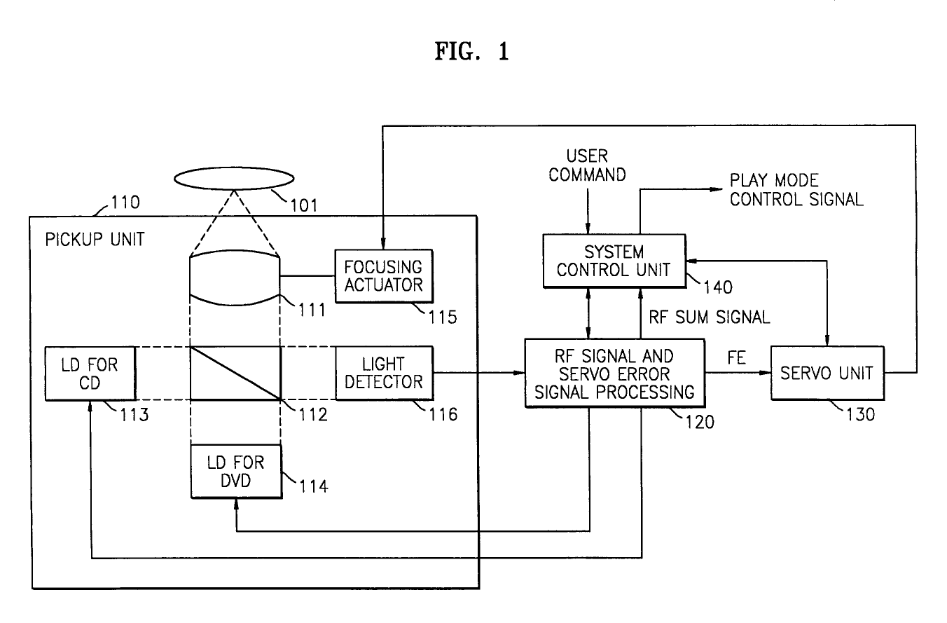

Referring to FIG. 1, a disc identification apparatus according to an embodiment of the present invention has a disc 101, a pickup unit 110, an RF signal and servo error signal processing unit 120, a servo unit 130, and a system control unit 140. The pickup unit 110 has an object lens 111, a beam splitter 112, a first laser diode (LD) for a CD (CD-type optical medium) 113, a second LD for a DVD (DVD-type optical medium) 114, a focusing actuator 115, and a light detector 116.

When a user command to identify a disc is generated, the system control unit 140 generates a command signal to the RF signal and servo error signal processing unit 120 to turn on the power of the first LD 113, and requests the servo unit 130 to perform a first focus search mode to identify a disc.

Then, the RF signal and servo error signal processing unit 120 provides power to drive the first LD 113 through an auto laser power control (ALPC) (not shown). The ALPC automatically controls the power of the first LD 113. Although the disc identification apparatus of FIG. 1 has the ALPC (not shown) in the RF signal and servo error signal processing unit 120, the ALPC may be located outside the RF signal and servo error signal processing unit 120.

The servo unit 130 provides a focus driving voltage (focus driver, also referred to as FOD) which controls the focusing actuator 115 to move up and down with respect to the disc 101 so that the pickup unit 110 can perform the first focus search mode for the disc 101. By moving up and down the focusing actuator 115, the object lens 111 is moved up and down, and the first focus search mode is performed. In the first focus search mode, a signal surface of the disc 101 enters into a depth of a focus of the objective lens 111.

When the first focus search mode is performed during driving the first LD 113, the light detector 116 detects a beam reflected from the signal surface of the disc 101 through the beam splitter 112 and transmits the detected beam to the RF signal and servo error signal processing unit 120.

The RF signal and servo error signal processing unit 120 generates a focus error signal (FE) and an RF sum signal based on a quantity of light (reflected beam) detected by the light detector 116. Using the detected quantity of light, the focus error signal and the RF sum signal are generated to identify the type of the disc.

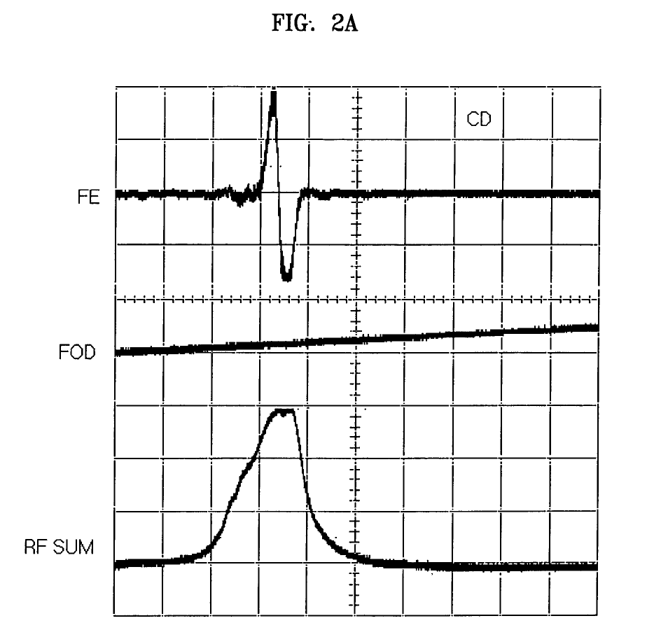

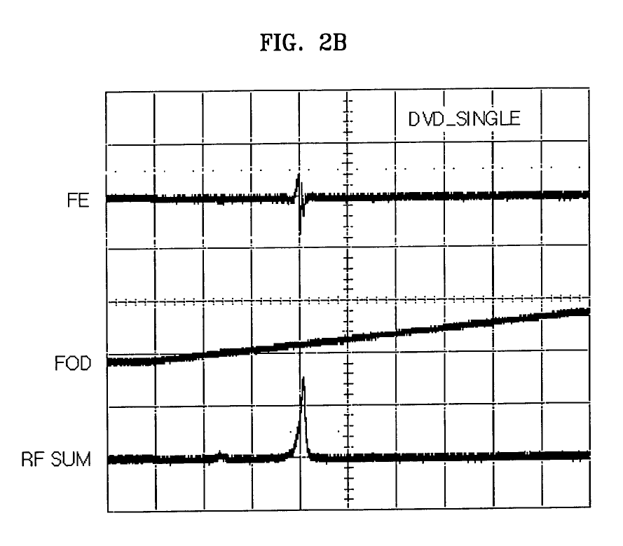

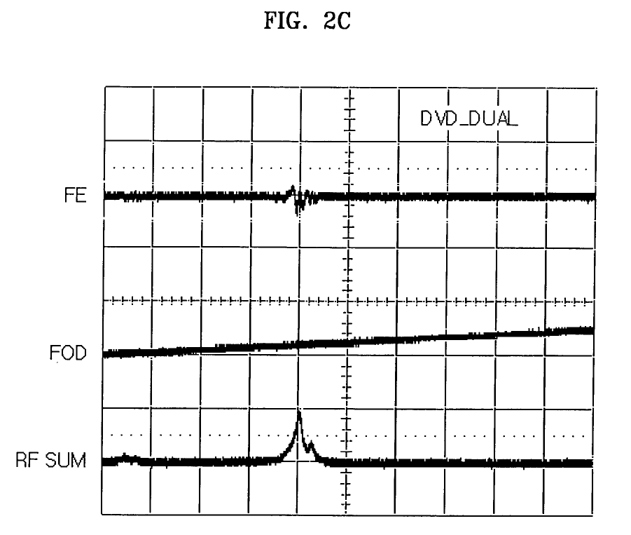

If a disc which is currently placed is the CD, during an up interval of the FOD to drive the focusing actuator 115 in the first focus search mode, the FE signal and the RF sum signal are generated as shown in FIG. 2A. If the disc which is currently placed is a single-layer DVD, during the up interval of the FOD to drive the focusing actuator 115 in the first focus search mode, the FE signal and the RF sum signal are generated as shown in FIG. 2B. If the disc which is currently placed is a dual-layer DVD, during the up interval of the FOD to drive the focusing actuator 115 in the first focus search mode, the FE signal and the RF sum signal are generated as shown in FIG. 2C. The generated FE signal is transmitted to the servo unit 120 while the generated RF sum signal is transmitted to the system control unit 140. The servo unit 120 detects a size (amplitude) of the FE signal. That is, the servo unit 120 detects a maximum value and a minimum value (peak-to-peak value) of the FE signal and transmits the maximum and minimum values to the system control unit 140.

The system control unit 140 compares the size of the FE signal provided by the servo unit 130 with a preset reference value (TH). If a result of the comparison indicates that the size of the FE signal is greater than the reference value (TH), it is determined that the disc which is currently placed is the CD, and a reproducing mode control signal is output so that the DVD reproducing system can automatically perform a CD reproducing mode.

However, if the size of the detected FE signal is not greater than the reference value (TH), it is determined that the disc which is currently placed is the DVD-type disc. At this time, the system control unit 140 does not use the RF sum signal. If it is determined that the placed disc is the DVD, the system control unit 140 outputs a signal to the RF signal and servo error signal processing unit 120 to turn on the power of the second LD 114 and requests the servo unit 130 to perform a second focus search mode.

Therefore, the RF signal and servo control signal processing unit 120 controls the second LD 114 to be turned on through the ALPC. The ALPC controls the power of the second LD 114. Accordingly, the first LD 113 stops radiating beams, and the second LD 114 radiates beams to the object lens 111 through the beam splitter 112. The object lens 111 is moved up and down by the focusing actuator 115 driven by the servo unit 130. Thus, the second focus search mode is performed.

Then, the light detector 115 detects the quantity of light reflected from the signal surface of the disc 101 through the beam splitter 112, and sends the detected quantity to the RF signal and servo error signal processing unit 120. In the same manner as the focus search mode with the first LD 113, the RF signal and servo error signal processing unit 120 detects a second RF sum signal and a second FE signal, and sends the second RF sum signal to the system control unit 140 and the second FE signal to the servo unit 130.

The servo unit 130 detects the peak-to-peak value of the second FE signal, and transmits the detected value to the system control unit 140. However, at this time, the system control unit 140 does not use the peak-to-peak value of the FE signal provided by the servo unit 130 but checks the number of peaks of the second RF sum signal provided during an FOD up or down interval. If the number of peaks of the second RF sum signal is 1, it is determined that the currently placed disc is the single-layer DVD, and the system control unit 140 outputs a second reproducing mode control signal so that a second reproducing mode for the single-layer DVD can be automatically performed. However, if the number of peaks of the second RF sum signal is 2, it is determined that the currently placed disc is the dual-layer DVD, and the system control unit 140 outputs a third reproducing mode control signal so that a third reproducing mode corresponding to the dual-layer DVD can be automatically performed.

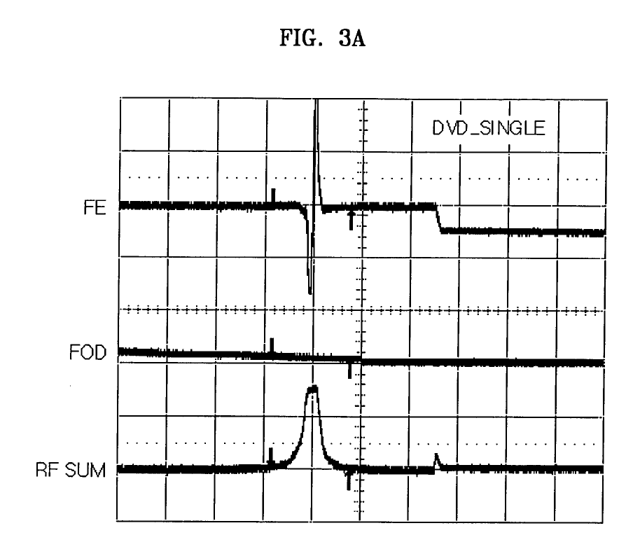

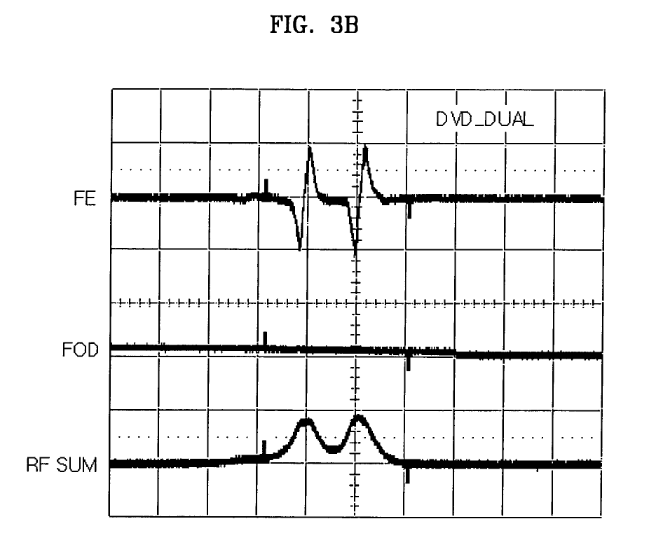

That is, if the placed disc is the single-layer DVD, the second FE signal and the second RF sum signal during the FOD down interval can be generated as shown in FIG. 3A. Meanwhile, if the placed disc is the dual-layer DVD, the second FE signal and the second RF sum signal during the FOD down interval can be generated as shown in FIG. 3A.

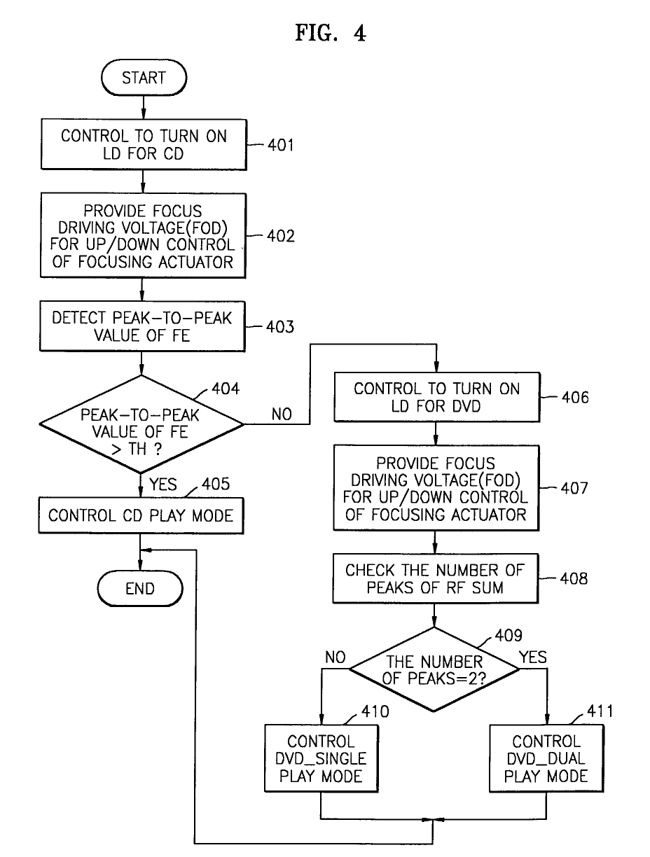

FIG. 4 is a flowchart of a disc identification method in the disc identification apparatus of FIG. 1. First, if there is a request to identify the type of the placed disc, the first LD for the CD 113 in a disc reproducing system is controlled to be turned on in operation 401. The FOD, to move up and down the focusing actuator 115 installed in the disc reproducing system, is provided to the focusing actuator 115 so as to perform the first focus search mode in operation 402.

Thus, the FE signal is detected in the first focus search mode. Then, the peak-to-peak value of the FE signal is detected in operation 403. The FE signal can be detected during the FOD up or down interval as shown in FIGS. 2A through 2C. The detected peak-to-peak value of the FE signal is compared with the reference value (TH) in operation 404. If the peak-to-peak value of the FE signal is greater than the reference value (TH), it is determined that the currently placed disc is the CD-type disc, and the CD reproducing mode (CD play mode) is controlled and performed in operation 405 and a disc identification process is finished.

In operation 404, the detected peak-to-peak value is not greater than the reference value (TH), the second LD 114 installed in the disc reproducing system is turned on in operation 406. The FOD to move up and down the focusing actuator 115 installed in the disc reproducing system is provided to the focusing actuator 115 so as to perform the second focus search mode in operation 407.

Thus, the RF sum signal is detected in the second focus search mode. Then, the number of peaks of the RF sum signal is checked in operation 408. The second RF sum signal can be detected during the FOD up interval in the focus search mode or during the FOD down interval as shown in FIGS. 3A and 3B.

In operation 409, if the number of peaks of the RF sum signal is not 2, it is determined that the currently placed disc is the single-layer DVD, and a DVD_SINGLE reproducing mode is controlled and performed to reproduce data from the single layer DVD in operation 410, and the disc identification process is finished.

Meanwhile, if in operation 409, the number of peaks of the second RF sum signal is 2, it is determined that the currently placed disc is the dual-layer DVD, and a DVD_DUAL reproducing mode is controlled and performed to reproduce data from the dual layer DVD in operation 411, and the disc identification process is finished.

According to the present invention described above, when an LD for a CD installed in a disc reproducing system is turned on, a first focus search mode is performed, a size (amplitude) of a detected FE signal is used, and the type of a placed disc is identified. By doing so, the accuracy of identifying whether the placed disc is a CD-type or DVD-type is enhanced. This is because when the LD for the CD is turned on, a difference of reflected beam quantities is great depending on whether the placed disc is the CD-type or DVD-type.

Also, after it is determined that the placed disc is the DVD-type, the disc identification method according to the present invention performs a second focus search mode, checks the number of peaks of a detected RF sum signal, and identifies the type of the placed disc while an LD for a DVD is turned on. Therefore, the accuracy of identification of whether the placed disc is a single-layer DVD or a dual-layer DVD is enhanced.

Although a few preferred embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A method of identifying a type of a disc in a disc reproducing system that reproduces data from 2 or more types of discs placed on the disc reproducing system, the method comprising:
performing a first focus search mode by turning on a first laser diode for a first optical medium type installed in the disc reproducing system;
detecting a peak-to-peak value of a focus error signal detected when the first focus search mode is performed;
identifying the type of the disc placed on the disc reproducing system by comparing the peak-to-peak value of the detected focus error signal with a predetermined reference value;
performing a second focus search mode by turning on a second laser diode for a second optical medium type installed in the disc reproducing system upon determining that the disc placed on the disc reproducing system is the second optical medium type; and
checking the number of peaks of an RF sum signal detected when the second focus search mode is performed, and identifying the type of the placed disc in response to the number of the peaks of the RF sum signal.

2. The disc identification method of claim 1, wherein the identifying of the type of the disc by using the peak-to-peak value of the focus error signal comprises:
if the peak-to-peak value of the focus error signal is greater than the predetermined reference value, determining that the disc is the first optical medium type; and
if the peak-to-peak value of the focus error signal is not greater than the predetermined reference value, determining that the disc is the second optical medium type.

3. The disc identification method of claim 1, wherein the identifying of the type of the disc by using the number of peaks of the RF sum signal comprises:
determining whether the disc is a single-layer optical medium or a dual-layer optical medium according to whether the number of peaks of the RF sum signal detected in a predetermined period is 2.

4. The disc identification method of claim 3, wherein the identifying of the type of the placed disc comprises generating a focus driving voltage having an up period or down period, and the predetermined period is one of the up period and the down period of the focus driving voltage.

5. The disc identification method of claim 1, wherein the first optical medium type is a CD type and the second optical medium type is a DVD type.

6. A disc identification apparatus in a disc reproducing system that reproduces data from 2 or more types of discs, the apparatus comprising:
a pickup unit which comprises a first laser diode for a first optical medium type, a second laser diode for a second optical medium type, and an optical detector that detects a quantity of a beam generated from one of the first laser diode and the second laser diode and reflected from a disc;
an RF signal and servo error signal processing unit which controls the power of the first laser diode for the first optical medium type and the second laser diode for the second optical medium type and generates a focus error signal and an RF sum signal based on the quantity of the beam detected by the optical detector;
a servo unit which detects a size of the focus error signal output from the RF signal and servo error signal processing unit; and
a system control unit which controls the RF signal and servo error signal processing unit and the servo unit so that the RF signal and servo error signal processing unit and the servo unit so that the RF signal and servo error signal processing unit turns on the first laser diode for the first optical medium type to perform a first focus search mode to identify the type of the disc based on the detected size of the focus error signal, so that, upon determining that the disc is the second optical medium type, the RF signal and servo error signal processing unit turns on the second laser diode for the second optical medium type to perform a second focus search mode to identify the type of the disc based on the number of the RF sum signal detected in a predetermined period.

7. The disc identification apparatus of claim 6, wherein the first optical medium type is a CD type, and the second optical medium type is a DVD type.

8. The disc identification apparatus of claim 6, wherein the RF signal and servo error signal processing unit generates a focus driving voltage having an up period or down period to perform the first and second focus search modes, and the predetermined period is one of the up period and the down period of the focus driving voltage.

9. A disc identification apparatus in a disc reproducing system that reproduces data from at least two types of discs placed on the disc reproducing system, the apparatus comprising:
a pickup unit generating a first laser beam in a first focus search mode and a second laser beam different from the first laser beam in a second focus search mode, detecting the first laser beam reflected from a disc placed on the disc reproducing system in the first focus search mode and the second laser beam reflected from the disc in the second focus search mode;
an RF signal and servo error signal processing unit generating a focus error signal in response to the detected first laser beam in the first focus search mode and an RF sum signal in response to the detected second laser beam in the second search mode; and
a system control unit determining the type of the disc in response to at least one of the focus error signal and the RF sum signal.

10. The disc identification apparatus of claim 9, wherein the type of the disc is one of a CD, a single layer DVD, and a dual layer DVD.

11. The disc identification apparatus of claim 9, wherein the system control unit changes the first focus search mode to the second focus search mode when the focus error signal indicates that the type of the disc is not a CD.

12. The disc identification apparatus of claim 9, wherein the system control unit uses the focus error signal in the first focus search mode to determine that the type of the disc is a CD without using the RF sum signal.

13. The disc identification apparatus of claim 9, wherein the system control unit uses the RF sum signal in the second focus search mode to determine that the type of the disc is one of a single layer DVD and a dual layer DVD without using the focus error signal.

14. The disc identification apparatus of claim 9, wherein the system control unit exclusively performs the first focus search mode and the second focus search mode.

15. The disc identification apparatus of claim 9, wherein the pickup unit comprises:
a first diode generating the first laser beam to reproduce data from a first type of the disc; and
a second diode generating the second laser beam to reproduce data from a second type of the disc.

16. The disc identification apparatus of claim 14, wherein the first type of the disc is a CD, and the second type of the disc is a DVD having one of a single layer DVD and a dual layer DVD.

17. The disc identification apparatus of claim 14, wherein the first laser beam has a first wavelength of about 780 nm, and the second laser beam has a second wavelength of between 635 and 650 inclusive.

18. The disc identification apparatus of claim 9, wherein the RF signal and servo error signal processing unit controls the pickup unit to generate the first laser beam in the first focus search mode to determine whether the disc is one of a first type disc and a second type disc and to generate the second laser beam in the second focus search mode to determine one of a first sub-type disc and a second sub-type disc when the disc is determined to be the second type.

19. The disc identification apparatus of claim 9, wherein the system control unit detects a peak-to-peak value of the focus error signal in the first focus search mode and compares the peak-to-peak value with a reference value to determine the type of the disc.

20. The disc identification apparatus of claim 19, wherein the system control unit determines that the type of the disc is a CD when the peak-to-peak value is greater than the reference value.

21. The disc identification apparatus of claim 20, wherein the system control unit determines that the type of the disc is a DVD when the peak-to-peak value is not greater than the reference value.

22. The disc identification apparatus of claim 20, wherein the RF signal and servo error signal processing unit controls the pickup unit to stop generating the first laser beam and to generate the second laser beam when the system control unit determines that the type of the disc is a DVD.

23. The disc identification apparatus of claim 20, wherein the system control unit changes the first focus search mode to the second focus search mode when the peak-to-peak value is not greater than the reference value.

24. The disc identification apparatus of claim 23, wherein the system control unit detects the number of peaks in the RF sum signal and compares the number of the peaks with a second reference value in the second focus search mode to determine the type of the disc.

25. The disc identification apparatus of claim 24, wherein the system control unit determines that the disc is a single layer DVD when the number of the peaks is not greater than the second reference value.

26. The disc identification apparatus of claim 24, wherein the system control unit determines that the disc is a dual layer DVD when the number of the peaks is greater than the second reference value.

27. A method of identifying a disc in a disc reproducing system, the method comprising:
generating a first laser beam in a first focus search mode to detecting the first laser beam reflected from the disc placed on the disc reproducing system;
generating a focus error signal in response to the detected first laser beam in the first focus search mode;
determining that the type of the disc is a first type disc in response to the focus error signal in the first focus search mode;
generating a second laser beam different from the first laser beam in a second focus search mode to detect the second laser beam reflected from the disc when the type of the disc is not the first type disc;
detecting an RF sum signal in response to the detected second laser beam; and
determining that the type of the disc is one of a second type disc and a third type disc based on the RF sum signal.
